(19) United States
(12) Patent Application Publication
(10) Pub. No.: US 2025/0222732 A1
(43) Pub. Date: Jul. 10, 2025

(54) HITCH BAR

(71) Applicant: Horizon Global Americas Inc., Cleveland, OH (US)

(72) Inventor: Mark SCRUGGS, Walled Lake, MI (US)

(73) Assignee: Horizon Global Americas Inc., Cleveland, OH (US)

(21) Appl. No.: 19/012,302

(22) Filed: Jan. 7, 2025

Related U.S. Application Data
(60) Provisional application No. 63/618,825, filed on Jan. 8, 2024.

(51) Int. Cl. B60D 1/46; B60D 1/07; B60D 1/52

(52) U.S. Cl. CPC B60D 1/46; B60D 1/075; B60D 1/52

(57) ABSTRACT

A hitch bar comprises a tubular member and second tubular member forming a vehicle end, a tubular towing member forming a towing and a gusset inserted into portions of the tubular member, second tubular member and tubular towing member.

### CLAIM OF PRIORITY TO PRIOR APPLICATION

This application claims the benefit of the filing date of U.S. Provisional Application, Ser. No. 63/618,825, filed on Jan. 8, 2024, entitled “Hitch Bar”. By this reference the entire disclosure, including the claims and drawings, of U.S. Provisional Application, Ser. No. 63/618,825 is hereby incorporated into the present disclosure as though now set forth in its entirety.

### FIELD OF INVENTION

The present invention relates generally to a hitch bar and, more specifically, a tubular hitch bar for use with a weight distribution system.

### BACKGROUND

Many vehicles are designed to transport freight, goods, merchandise, personal property, and other such cargo. Often, such vehicles are arranged to tow a towed vehicle, such as a trailer by attaching the towed vehicle to the towing vehicle though the use of a hitch bar and receiver hitch. For example, a hitch bar may be a part of the overall mechanism to attach a towed vehicle to a towing vehicle such as through a receiver hitch, hitch ball and coupler arrangement. This configuration allows relative movement between the towing vehicle and the towed vehicle as the towing vehicle moves, such as in making turns, traversing uneven or rough terrain, and passing along inclining and declining roadways.

For towed vehicle over a defined rated capacity, a weight distribution system may be utilized. In such cases, the weight distribution system may be utilized to control the sway of the towed vehicle during normal operating conditions. Specifically, a distribution of the weight of a towed vehicle among the axles of the towing vehicle is important to the effective operation of a towing vehicle. Towed vehicles are often loaded with heavy cargo and may substantially outweigh the towing vehicle. When such a towed vehicle is coupled or secured to the rear of a towing vehicle, the majority of the tongue weight of the towed vehicle may be born by the rear axle of a towing vehicle. Such uneven weight distribution may lower the rear of the towing vehicle and raise the front of the towing vehicle. Under such conditions, the tires of the rear axle may bear substantially more weight than the tires of the front axle of the towing vehicle.

Controlling the sway movement of the towed vehicle (i.e., lateral or side-to-side movement of the towed vehicle with respect to the towing vehicle) relative to the towing vehicle as the towed vehicle is towed is also important to the effective operation of a towing vehicle. While relative motion of the towed vehicle with respect to the towing vehicle is necessary to accommodate turns and inclining and declining roadways, excess sway of the towed vehicle may be undesirable. This may be particularly true when the load that is being towed is heavy relative to the weight of the towing vehicle.

Many factors may contribute to the swaying of a towed vehicle. For example, crosswinds impacting the towed vehicle; unevenly loaded towed vehicles; inclined, declined, and sloped roadways; winding roadways; and rough and uneven terrain may all contribute to swaying of the towed vehicle. Such factors may be exacerbated as the speed of the vehicle increases. As previously mentioned, towed vehicles and cargo may substantially outweigh a towing vehicle. When such a towed vehicle begins to sway, particularly when driven at high speeds such as on a highway, the towed vehicle may transfer sufficient side-to-side and lateral forces to the towing vehicle to cause undesirable driving conditions.

In such weight distribution systems, a specific hitch bar is utilized. These hitch bars can be very heavy to maneuver and position on the towing vehicle. There is a need, therefore, for a hitch bar that is of lighter weight that maintains the strength and functionality. The present teachings, however, are not limited to this benefit. There may be other and additional benefits of the present teachings as evident from the disclosure below.

### SUMMARY

A hitch bar with lighter weight that maintains previous strength. The hitch bar comprises a tubular member and second tubular member forming a vehicle end, a tubular towing member forming a towing and a gusset inserted into portions of the tubular member, second tubular member and tubular towing member.

### DESCRIPTION OF THE DRAWINGS

Operation of the present teachings may be better understood by reference to the detailed description taken in connection with the following illustrations. These appended drawings form part of this specification, and written information in the drawings should be treated as part of this disclosure. In the drawings:

FIG. 1 is a rear perspective view of an embodiment of a hitch bar described herein;

FIG. 2 is a front perspective view of the hitch bar described herein;

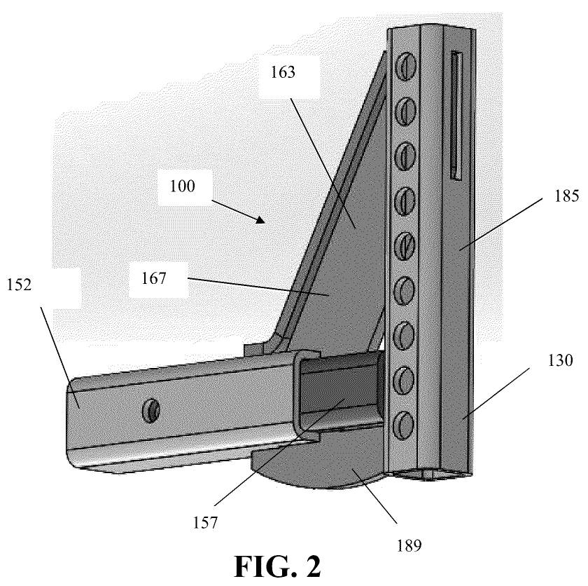

FIG. 3 is a side perspective view of the hitch bar described herein;

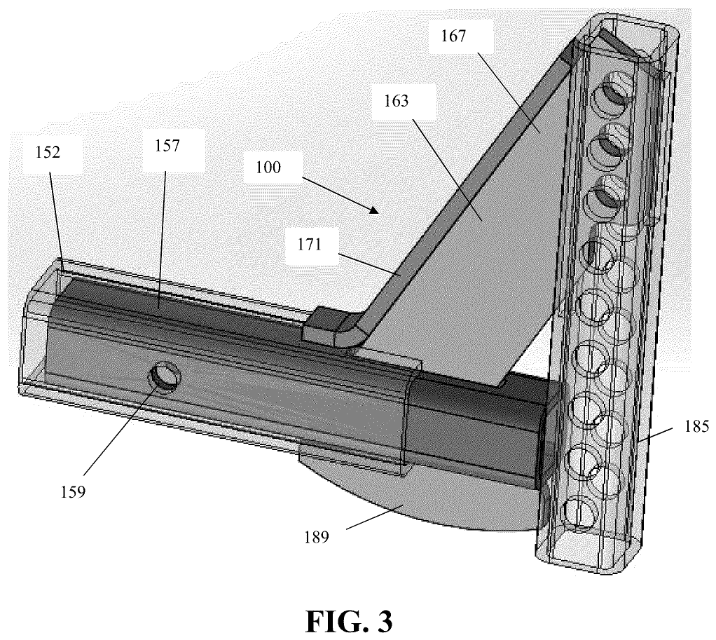

FIG. 4 is a side view of the hitch bar with a one-piece gusset;

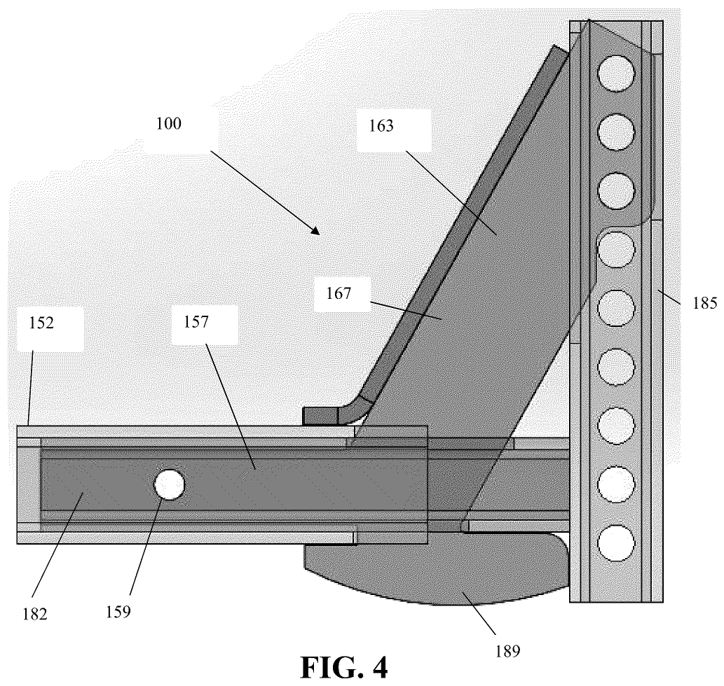

FIG. 5 is a perspective view of an embodiment of a weight distribution system.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality, such those from other described embodiments herein. It is further noted that while various embodiments refer to a hitch bar, various other systems may be utilized in view of embodiments described herein. Further, the present system may include a variety of components, not limited to the components discussed below. Optionally, the present system may include multiple units of the same components. In an embodiment, the present system may include just the hitch bar described herein. Further, the present system may include components of each of the hitch bar to create a combination of each feature of the various systems.

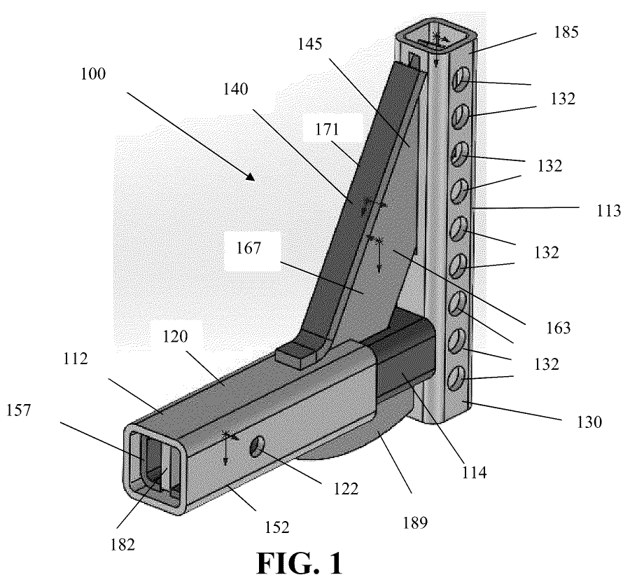

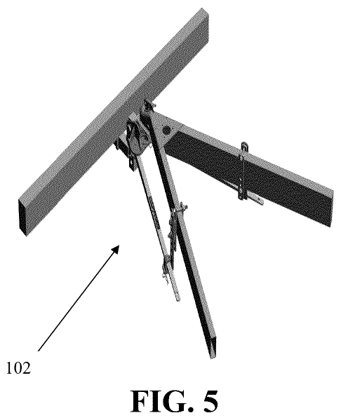

A towing vehicle may be provided with a hitch assembly that is connected to a tongue of a towed vehicle. The tongue of the towed vehicle may be attached to the hitch assembly in order to distribute some of the weight of the towed vehicle to the front axle of the towing vehicle and to the axles of the towed vehicle. The hitch assembly may include a hitch bar 100, which is shown in FIG. 1. The hitch bar 100 may be adapted to be selectively connected to a hitch receptacle (or a receiver tube) mounted to the rear portion of the vehicle. By way of a non-limiting example, the hitch assembly may include a receiver hitch, which may be attached to the frame of the towing vehicle in any manner. The present teachings are not limited to a specific receiver hitch, but may be utilized with any type or configuration of receiver hitch. A merely exemplary receiver hitch may include a REESE custom fit hitch or REESE multi-fit hitch. The receiver hitch may include a receiver tube, such as a generally square receiver tube, that may be of any appropriate size. An example of such sizes may include 1.25-inch×1.25 inch (Class I and II hitches), 2-inch×2-inch (Class III and IV hitches), 2-inch×2-inch (heavy duty), 2.5 inch×2.5 inch (Class V hitch) and 3-inch×3-inch (heavier duty). The present teachings, however, are not limited to these sizes. The hitch bar 100 may be of a size to operatively fit any one of the above-mentioned receiver tubes. The hitch bar 100 may be utilized with a weight distribution towing system 102, an example of which is shown in FIG. 5.

As shown in FIG. 1, the hitch bar 100 may include a vehicle end (or a vehicle attachment portion) 112 and an opposite towing end (or a shank) 113 along with a base end 114. These ends 112, 113, 114 may intersect to form a generally L-shaped configuration to allow the towing end 113 to be positioned generally perpendicularly related to the vehicle end 112. The vehicle end 112 of the hitch bar 100 may be selectively coupled to the hitch receptacle (or a receiver tube) in any appropriate manner.

In one embodiment, the hitch bar 100 may include a horizontal portion 120, a vertical portion 130, and a transitional portion 140. The horizontal portion 120 may be positioned at the vehicle end 112 and may include a generally square or rectangular shape configured to be operatively inserted into the hitch receptacle (or the receiver tube). In some embodiments, the horizontal portion 120 may include a generally square tubular shape, i.e., the corners are close to but do not need to be exactly at 90 degree angles relative to one other. For example, the corners could be between 80-100 degrees relative to one another. The present teachings, however, are not limited to this shape. Any appropriate shape may be utilized, such as one that is generally oval, circular or rectangular, one generally square or rectangular with an additional cut-out and the like.

The vertical portion 130 or shank may be positioned at the towing end 113 and may be formed from a generally tubular member as described in more detail below. The vertical portion 130, however, may be of any appropriate shape, including, without limitation being generally circular or oval in shape. Additional exemplary embodiments of the vertical portion 130 may include those embodiments shown in U.S. Pat. Nos. 8,979,112 and 9,199,520, which are both incorporated herein by reference. The transitional portion 140 may be connected to the horizontal portion 120 and extend along the base end 114 from the vehicle end 112 to the opposite towing end 113.

The towing end 113 may be formed from a first tubular member 152 that is shaped and sized to be inserted into the applicable hitch receiver as described above. The tubular member 152 may include a locking pin aperture 122, which may be of any configuration such as being generally circular in cross-sectional shape to accept a locking pin (or a hitch pin). The locking pin of any appropriate configuration may be inserted through a corresponding locking pin aperture (not shown) in the hitch receptacle. The locking pin may be secured in place by a clip for securing the horizontal portion 120 of the hitch bar 100 within the hitch receptacle, or any other appropriate method, such as a lock and lock body.

The towing end 113 may further include a second tubular member 157 that may be inserted into the tubular member 152. The second tubular member 157 may be of a substantially same shape as the tubular member 152 but smaller so as to be inserted into the tubular member 152. The second tubular member 157 may be fixed to the tubular member 152 in any appropriate manner, such as being welded directly together, by being welded with the transitional portion 140 as described in more detail below, or both. The second tubular member 157 may include a second locking pin aperture 159, which may be of the same configuration as the locking pin aperture 122 and utilized for the same purpose as described above for the locking pin aperture 122.

The vertical portion 130 may be a generally tubular, i.e., the tubular towing member 185 so as to allow a towing member to be operatively attached thereto. The tubular towing member 185 may include plurality of towing apertures 132 that may be utilized to selectively attach the towing member in a plurality of operative positions, such as that described in U.S. Pat. Nos. 8,979,112 and 9,199,520. The towing member may, for example, be mounted to a coupler of the towing vehicle. The towing member may be of any appropriate configuration and not limited to a hitch ball configuration. Further, the towing member may include a single hitch ball, a plurality of hitch balls, a pintle hook, a hook, a step, or any combination of the foregoing.

The transitional portion 140 may comprise a gusset 163. The gusset 163 may comprise a plurality of different shapes and isn't limited to the one shown. In the embodiments shown, the gusset 163 may be inserted into the tubular member 152, the second tubular member 157 and the vertical portion 130. The transitional portion 140 may comprise a generally planar plate member 167, i.e., within 5 degrees of being flat. As shown, the generally planar plate member 167 may extend below the tubular member 152 and second tubular member 157. A reinforcing plate 171 may be attached to the plate member 167 to form the gusset 163. The reinforcing plate 171 may provide additional stability to the gusset 163 and/or may provide a finished look thereto. The reinforcing plate 171 may be attached to the plate member 167 in any appropriate matter, including, without limitation via welding, fastening, adhesive or a combination thereof. In most embodiments, the reinforcing plate 171 will be welded to the plate member 167. In still yet other embodiments, the reinforcing plate 171 may be monolithically formed with the plate member 167 or may not be included at all.

The plate member 167 may be inserted into the tubular member 152 and second tubular member 157. Each of the tubular member 152 and the second tubular member 157 may include slots or openings into which the plate member 167 may be inserted. The plate member 167 may then be welded to each of the tubular member 152 and the second tubular member 157. The plate member 167 in some embodiments, may be welded to the tubular member 152 and second tubular member 157 on both sides thereof. Welding on both sides of the tubular member 152 and second tubular member 157 may lower stress on the welds as well as reducing stress on the tubular member 152 and second tubular member 157 as well as the gusset 163.

In some embodiments, the plate member 167, or a portion thereof, may extend into the second tubular member 157 as shown in FIG. 1—see the extension portion 182. The extension portion 182 may provide additional support and stability to the vehicle end 112. Further, the extension portion 182 may include a locking pin aperture (not shown) such that the locking pin of any appropriate configuration may be inserted through the locking pin aperture of the extension portion 182 as well as the locking pin apertures 122 and the second locking pin apertures 132.

In some embodiments, the plate member 167 may include a second extension 189 that extends through second openings in a bottom surface of the tubular member 152 and second tubular member 157. The second extension 189 may be welded or otherwise attached to the bottom surface of the tubular member 152 and second tubular member 157. The second extension 189 may be welded to the tubular member 152 and second tubular member 157 on both sides thereof, which can result in lower stresses during operation of the hitch bar 100. The second extension 189 may also provide additional support and stability.

The plate member 167 may also be inserted into the tubular towing member 185. In these embodiments, the tubular towing member 185 may include an opening or slot and the plate member 167 may be inserted therein. The plate member 167 may be welded or otherwise attached to the tubular towing member 185. The plate member 167 may be welded on both sides thereof to lower the stress to the tubular towing member 185, the plate member 167 and the welds themselves.

The plate member 167 be inserted into the tubular towing member 185 may provide additional structural support to allow the vertical portion 130 to maintain its structural orientation relative to the horizontal portion 120. Further, the plate member 167 may include apertures that correspond to the towing apertures 132. These apertures will allow the head bolts to pass through the plate member 167 to add redundancy and support.

The gusset 163 may provide additional support to the hitch bar 100. The gusset 163 may act as a stiffener for each of the tubular member 152, the second tubular member 157 and the tubular towing member 185. In some embodiments, the gusset 163 or more specifically the plate member 167 may be formed from a single monolithic piece, which may act as a stiffener for the hitch bar 100.

The aforementioned embodiments may provide a hitch bar with a lower weight, e.g., 21 pounds versus 26 pounds. Moreover, the hitch bar 100 utilizes readily available material, which can reduce the cost of producing same. Further, the hitch bar 100 does not require machining of a solid bar or drilling. Instead, the hitch bar 100 may be formed through use of a tube laser cutting machine, which may reduce the time needed to product the hitch bar 100.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

Having thus described the invention, the following is claimed:

1. A hitch bar for a towing vehicle, comprising:
a horizontal portion configured to be operatively inserted into a hitch receptacle of the towing vehicle, the horizontal portion including:
a first tubular member sized to be inserted into a hitch receiver of the towing vehicle, the first tubular member including a locking pin aperture for securing the hitch bar within the hitch receptacle;
a second tubular member inserted into the first tubular member and fixed to the first tubular member, the second tubular member including a second locking pin aperture;
a vertical portion configured to connect to a towing member, the vertical portion including:
a generally tubular structure; and
a plurality of towing apertures spaced apart along the vertical portion, each towing aperture configured to receive a fastener for selectively attaching the towing member in a plurality of operative positions; and
a transitional portion connecting the horizontal portion and the vertical portion, the transitional portion including a gusset formed from a plate member, the plate member extending into the horizontal portion and the vertical portion to provide structural support.

2. The hitch bar of claim 1, wherein the second locking pin aperture being of the same configuration as the locking pin aperture in the first tubular member and configured to be used for securing the hitch bar within the hitch receptacle.

3. The hitch bar of claim 1, wherein the first tubular member and the second tubular member are welded together.

4. The hitch bar of claim 1, wherein the locking pin aperture and the second locking pin aperture are aligned to allow a single locking pin to secure both the first tubular member and the second tubular member within the hitch receptacle.

5. The hitch bar of claim 1, wherein the second tubular member is inserted into the first tubular member and secured using both welding and an adhesive bonding material to ensure durability under heavy towing conditions.

6. The hitch bar of claim 1, wherein the towing apertures in the vertical portion are configured to align with corresponding apertures in a towing member to facilitate rapid attachment and detachment of the towing member.

7. The hitch bar of claim 1, wherein the plurality of towing apertures are evenly spaced along the vertical portion and configured to provide balanced load distribution when attaching towing members of varying sizes.

8. The hitch bar of claim 1, wherein the reinforcing plate in the transitional portion is welded to both the horizontal portion and the vertical portion to minimize stress concentration during towing operations.

9. The hitch bar of claim 1, wherein the second tubular member includes an extension portion that extends into the gusset to provide additional reinforcement for the horizontal portion.

10. The hitch bar of claim 1, wherein the gusset comprises a slot or opening for accommodating a portion of the reinforcing plate.

11. A method of attaching a towing member to a hitch bar, comprising the steps of:
inserting a first tubular member of a horizontal portion of a hitch bar into a hitch receptacle of a towing vehicle;
securing the first tubular member within the hitch receptacle using a locking pin passing through a locking pin aperture in the first tubular member;
inserting a second tubular member into the first tubular member, the second tubular member having a second locking pin aperture;
securing the second tubular member in place using a locking pin passing through the second locking pin aperture and the locking pin aperture in the first tubular member;
connecting a vertical portion to the horizontal portion of the hitch bar, the vertical portion having a plurality of towing apertures; and
attaching the towing member to the vertical portion by selectively inserting fasteners into the towing apertures.

12. The method of claim 11, wherein the first tubular member and the second tubular member are welded together.

13. The method of claim 11, further comprising the step of applying corrosion-resistant coating to the horizontal portion, the vertical portion, and the transitional portion prior to assembly.

14. The method of claim 11, wherein the plurality of towing apertures are evenly spaced along the vertical portion and configured to provide balanced load distribution when attaching towing members of varying sizes.

15. The method of claim 11, wherein the second locking pin aperture being of the same configuration as the locking pin aperture in the first tubular member.

16. The method of claim 11, wherein the locking pin aperture and the second locking pin aperture are aligned to allow a single locking pin to secure both the first tubular member and the second tubular member within the hitch receptacle.

17. The method of claim 11, wherein the towing apertures in the vertical portion are configured to align with corresponding apertures in a towing member to facilitate rapid attachment and detachment of the towing member.

18. The method of claim 11, further comprising the step of welding the transitional portion to both the horizontal portion and the vertical portion to minimize stress concentration during towing operations.

19. The method of claim 11, wherein the second tubular member includes an extension portion that extends into the gusset to provide additional reinforcement for the horizontal portion.

20. A hitch bar for a towing vehicle, comprising:
a horizontal portion configured to be operatively inserted into a hitch receptacle of the towing vehicle, the horizontal portion including:
a first tubular member sized to be inserted into a hitch receiver of the towing vehicle, the first tubular member including a locking pin aperture;
a second tubular member inserted into the first tubular member and fixed to the first tubular member, the second tubular member including a second locking pin aperture, wherein the locking pin aperture of the first tubular member and the second locking pin aperture are aligned to allow a single locking pin to secure both the first tubular member and the second tubular member within the hitch receptacle;
a vertical portion configured to connect to a towing member, the vertical portion including:
a generally tubular structure; and
a plurality of towing apertures spaced apart along the vertical portion, each towing aperture configured to receive a fastener for selectively attaching the towing member in a plurality of operative positions; and
a transitional portion connecting the horizontal portion and the vertical portion, the transitional portion comprising:
a gusset formed from a plate member, the plate member extending into the horizontal portion and the vertical portion to provide structural support; and
a reinforcing plate attached to the plate member to enhance stability.
